(19) United States
(12) Patent Application Publication
(10) Pub. No.: US 2004/0168397 A1
(43) Pub. Date: Sep. 2, 2004

(54) Shear connector

(76) Inventors: Juergen Gruen, Boetzingen (DE); Rainer Jakob, Emmendingen (DE); Paul Steurer, Teningen (DE); Rainer Wohlgethan, Grezach-Wyhlen (DE)

Correspondence Address: Striker Striker & Stenby, 103 East Neck Road, Huntington, NY, 11743, US

(21) Appl. No.: 10/479,679

(22) PCT Filed: May 14, 2002
(86) PCT No.: PCT/EP02/05275

(30) Foreign Application Priority Data
Jun. 19, 2001 (DE) 101294417

(51) Int. Cl. E04B 1/38; E04C 5/00

(52) U.S. Cl. 52/704; 52/698

(57) ABSTRACT

The invention relates to a composite anchor, which consists of an anchor rod (1) anchorable by means of a compound mass in a hole (12) drilled in a building component (13), the anchor rod comprising several cone-like segments (3a, 3b, 3c) widening towards the insertion end (4) and spaced from one another by cylindrical portions (6a, 6b). The length of the cylindrical portions (6a, 6b) is 0.5 times to 2.0 times the length of the cone-like segment (3a, 3b) adjoining the respective portion in the direction of the insertion end (4). This produces a stable mortar shell (14) after the compound mass has hardened, which causes high withdrawal values as a consequence of the cone-like segments (3a, 3b, 3c) settling into the hardened mortar shell (14) following widening of the drilled hole as a result of cracks forming. The composite anchor is therefore especially suitable for anchoring in zones subject to tensile forces.

The invention relates to a composite anchor, especially for anchoring in zones subject to tensile forces, in accordance with the preamble to claim 1.

A composite anchor of the kind mentioned in the preamble is known from EP 0 867 624 B1, having an anchor rod that comprises several cone-like segments widening towards the insertion end and is anchorable by means of a compound mass in a hole drilled in a building component. The suitability of the known anchor rod for anchorings in zones subject to tensile forces, with no coating on the cone-like segments and no wire sleeve for protection of the coating, was achieved by reducing the amount of aggregate, such as quartz sand, in the compound mass, and by offsetting the ensuing reduction in bond strength after hardening of the compound mass by reducing the ratio of the drilled hole-annular gap area to the bolt cross-section to a value between 0.3 and 0.5.

The suitability of a composite anchor in zones subject to tensile stress is furthermore dependent on the fact that an axial displacement of the anchor rod in the hardened shell of mortar, and hence subsequent expansion, is rendered possible. During this displacement, the cone-like segments settle back into the narrower region of the mortar shell, so that the interlocking braced engagement between anchor rod and mortar shell is reinstated. For the anchor rod to be displaced with respect to the mortar shell, it is necessary for the outer surface of the anchor rod to become completely detached from the mortar shell, whilst the bond between the mortar shell and the wall of the drilled hole is maintained. In the case of the known anchor rod, the value of the ratio of the bond area to the cone area is between 3 and 4.5, which ensures detachment of the outer surface of the anchor rod from the mortar shell.

Achieving high holding values in zones subject to tensile stress with the known composite anchor requires a minimum number of cone-like segments, which allows no or only a short distance formed by cylindrical portions between the individual cone-like segments. As the number of cone-like segments increases, however, the expansion force acting on the mortar shell when a pull is exerted on the anchor rod also increases, the effect of which is to increases the edge and centre distances.

Taking this state of the art as a starting point, the invention is based on the problem of improving a composite anchor of the kind mentioned in the introduction suitable for zones subject to tensile stress so that, on the one hand, high withdrawal values are achieved and, on the other hand, it is possible to reduce the edge and centre distances by reducing the expansion pressure forces deriving from the cone-like segments.

This technical problem is solved by the features specified in claim 1. The length of the cylindrical portions arranged between the cone-like segments corresponds to 0.5 times to 2.0 times the length of the cone-like segment adjoining the respective cylindrical portion in the direction of the insertion end. After hardening of the compound mass, a longer mortar shell with a thicker wall in the region of the cylindrical portion is therefore produced. When a tensile load acts on the anchor rod, this cylindrical portion of the mortar shell is able to absorb higher forces against pull-through of the cone-like segment. The increased pull-through force enables the number of cone-like segments in relation to the same anchoring length to be reduced compared with the known anchor rod. Thus, for example, the known anchor rod requires five cone-like segments to achieve approximately the same withdrawal force as the anchor rod according to the invention having, for example, three cone-like segments.

A larger number of the cone-like segments inevitably also causes a higher expansion force acting on the hardened mortar shell when a tensile load acts on the anchor rod. The smaller number of cone-like segments therefore reduces the expansion force in the case of the anchor rod according to the invention, which allows smaller distances to the edge of a concrete part or to the next fixing point (centre distance).

In a further construction of the invention, the diameter of the cylindrical portions arranged between the cone-like segments can increase, starting from the insertion end, and their length can decrease, the diameter of the cylindrical portions being less, preferably by 0.5 times to 0.75 times, than the outer diameter of the anchor rod. The cylindrical portion associated with the cone-like segment arranged at the insertion end therefore has the smallest diameter, so that the mortar shell formed around this cylindrical portion has the greatest wall thickness and hence presents the greatest resistance to pulling of the cone-like segment through the mortar shell. The cylindrical portion having the largest diameter and located furthest away from the insertion end determines with its cross-section the steel load bearing capacity of the anchor rod. This advantageous development produces a further improvement in the withdrawal value of the composite anchor according to the invention.

The front face formed at the transition from a cone-like segment to a cylindrical portion is preferably in the form of a conical surface with an angle to the centre line of between 45° and 85°. This configuration on the one hand prevents a stress concentration at the anchor rod and on the other hand facilitates detachment of the outer surface of the anchor rod from the mortar shell in the event of the drilled hole widening as a result of cracks forming.

A further construction of the invention, in which a conical region adjoins the cone-like segment located furthest away from the insertion end, serves the same purpose; this conical region widens towards the rear end of the anchor rod at a shallow angle of preferably between 1.5° and 4°. Even a slight axial displacement of the anchor rod relative to the mortar shell is therefore sufficient to achieve a separation of the adhesive bond to the anchor rod. Furthermore, as the anchor rod is driven into the drilled hole, this conical region gradually commutes any grains of the aggregate that are still coarse, and thus prevents coarse grains or fragments of the aggregate from being pressed into the relatively narrow annular gap. This construction is primarily of advantage when the composite anchor is used in conjunction with a glass capsule.

A further construction, in which the anchor rod has at its insertion end a mixing tip formed by an oblique face inclined to the centre line, is also advantageous for use in conjunction with a glass capsule. This mixing tip on the one hand crushes the glass capsule and on the other hand blends the two components of the resin system with one another.

Finally, the anchor rod can be provided with a polygonal profile, preferably a hexagonal profile, on its outer surfaces of maximum dimension of the anchoring region. The corner edges of the polygonal profile score the mortar shell longitudinally, so that the cross-sectional weakening of the mortar shell present at the corner edges facilitates breaking open thereof and hence subsequent expansion.

Exemplary embodiments of the invention are explained in detail below with reference to the drawings, in which:

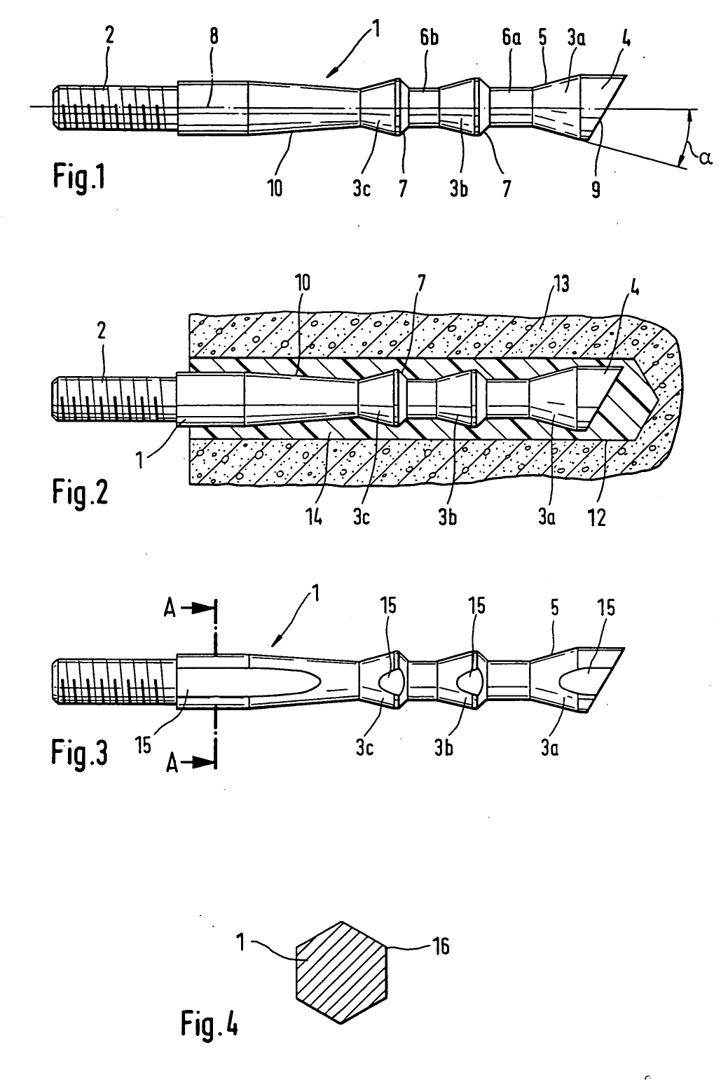

FIG. 1 shows, in side view, an anchor rod according to the invention;

FIG. 2 shows the anchor rod according to FIG. 1 bedded into mortar in a hole drilled in a building component;

FIG. 3 shows, in side view, a further embodiment of the anchor rod; and

FIG. 4 shows the section A-A indicated in FIG. 3.

The composite anchor illustrated in FIGS. 1 and 2 consists of an anchor rod 1, which at its rear end has an external thread 2 for attachment of an article. The anchoring region is formed by several, in the exemplary embodiment three, cone-like segments 3a, 3b and 3c, each of which has a conical surface 5 widening towards the insertion end. Cylindrical portions 6a, 6b, which each extend with the smallest diameter of the cone-like segments towards the external thread 2 of the anchor rod 1, are arranged between the individual cone-like segments 3a, 3b, 3c.

The cylindrical portions 6a, 6b have a length that can correspond to 0.5 to 2.0 times the length of the cone-like segment adjoining the respective portion in the direction of the insertion end 4. Furthermore, the diameter of the cylindrical portions 6a, 6b increases starting from the insertion end 4 towards the external thread 2 of the anchor rod 1, whilst their length decreases. The cylindrical portion 6a accordingly has a smaller diameter and a longer length than the cylindrical portion 6b. Since the largest diameter of the cone-like segments is the same in each case, the length of the conical surface 5 of the cone-like segment 3a is inevitably longer than that of the respective cone-like segments 3b and 3c lying before it. The angle of taper α is preferably between 12° and 20°.

The front face 7 formed at the transition of the cone-like segments 3b, 3c to the respective cylindrical portion 6a, 6b is in the form of a conical surface having an angle to the centre line 8 of between 45° and 85°. At the insertion end 4, the anchor rod 1 is provided with a mixing tip, which is formed by an oblique face 9 inclined to the centre line 8.

Adjoining the cone-like segment 3c is a conical region 10, which widens towards the external thread 2 at a shallow angle, of preferably from 1.5° to 4°.

FIG. 2 illustrates the anchoring of the anchor rod 1 in a hole 12 drilled in a building component 13 by means of the compound mass hardened to a mortar shell 14. The compound mass can be introduced in the form of a glass capsule or a cartridge with static mixer into the drilled hole 12. In both cases, a compound mass is usually used, the resin components being based on unsaturated polyester resins and/or vinyl urethane resins and/or epoxy resins and/or polyurethane resins and/or vinyl ester resins and/or mineral binding agents. A dibenzol peroxide, which is stabilised in plaster, is used as hardener component.

Once the compound mass has been introduced into the drilled hole 12, the anchor rod 1 is driven mechanically using a hammer drill or with hammer blows into the drilled hole. If the compound mass is introduced by means of a capsule, this is crushed as the anchor rod 1 is driven in, and at the same time the components of the compound mass are mixed. Once the compound mass has hardened, it forms a hard shell of mortar 14 having an inner contour corresponding to the outer surface of the anchor rod 1.

If, after an article has been fixed, the drilled hole widens owing to the formation of cracks in the building component 13, because of the greater braced engagement between the wall of the drilled hole and the mortar shell 14 compared with the braced engagement between the outer surface of the anchor rod 1 and the mortar shell, at least in regions of the outer surface of the anchor rod 1 a detachment is effected, which leads to a slight axial displacement of the anchor rod 1 relative to the mortar shell 14 under the influence of the tensile load acting on the anchor rod 1. The displacement continues until the conical surfaces 5 of the cone-like segments 3a, 3b and 3c again abut the inner conical surfaces of the mortar shell formed during hardening, and in so doing allow the maximum holding value by virtue of the renewed interlocking engagement and the developing expansion pressure. Whereas the conical surfaces 5 of the cone-like segments 3a, 3b and 3c are re-clamped by the axial displacement, the oppositely directed conical surfaces of the front face 7 at the transition of a cone-like segment to a cylindrical portion and of the conical region 10 adjoining the cone-like segment 3c create spaces which facilitate the subsequent expansion effect.

Because of the different diameters of the cylindrical portions 6a, 6b, the portion of the mortar shell located closest to the insertion end 4 has the greatest wall thickness and the longest length. The pull-through force is therefore highest for the cone-like segment 3a with the greatest anchoring depth.

The exemplary embodiment of the anchor rod 1 illustrated in FIGS. 3 and 4 is provided on its outer surfaces of maximum dimension with a polygonal profile 15, preferably a hexagonal profile. After the mortar shell 14 has hardened, longitudinally running cross-sectional weakenings consequently occur at the corner edges 16, these weakenings facilitating breaking open of the mortar shell upon axial displacement of the anchor rod 1 relative to the mortar shell, especially in the region of the cone-like segments 3a, 3b and 3c. Breaking open produces individual segments in the region of the conical surfaces 5 of the cone-like segments 3a, 3b and 3c, which promote the build-up of an expansion pressure and hence the subsequent expansion effect.

1. Composite anchor, especially for anchoring in zones subject to tensile forces, which consists of an anchor rod (1) anchorable by means of a compound mass in a hole drilled in a building component, the anchor rod comprising several cone-like segments (3a, 3b, 3c) widening towards the insertion end (4) and spaced from one another by cylindrical portions (6a, 6b), characterised in that the length of the cylindrical portions (6a, 6b) is 0.5 times to 2.0 times the length of the cone-like segment (3a, 3b) adjoining the respective portion in the direction of the insertion end (4).

2. Composite anchor according to claim 1, characterised in that the diameter of the cylindrical portions (6a, 6b) arranged between the cone-like segments (3a, 3b, 3c) increases, starting from the insertion end (4), and their length decreases.

3. Composite anchor according to claim 1, characterised in that compared with the outer diameter of the anchor rod (1) the diameter of the cylindrical portions (6a, 6b) is reduced by 0.5 times to 0.75 times.

4. Composite anchor according to claim 1, characterised in that the anchor rod (1) is provided with at least two, preferably three, cone-like segments (3a, 3b, 3c), the angle of taper (α) of which is between 12° and 20°.

5. Composite anchor according to claim 1, characterised in that the front face (7) formed at the transition of a cone-like segment (3a, 3b, 3c) to a cylindrical portion (6a, 6b) is in the form of a conical surface having an angle to the centre line (8) of between 45° and 85°.

6. Composite anchor according to claim 1, characterised in that the anchor rod (1) has at its insertion end (4) a mixing tip formed by an oblique face (9) inclined to the centre line (8).

7. Composite anchor according to claim 1, characterised in that a conical region (10) adjoins the cone-like segment (3c) located furthest away from the insertion end (4), this conical region widening towards the rear end of the anchor rod (1) at a shallow angle of preferably between 1.5° and 4°.

8. Composite anchor according to claim 1, characterised in that the anchor rod (1) is provided on its outer surfaces of maximum dimension with a polygonal profile (15).
